(19) United States
(12) Patent Application Publication
(10) Pub. No.: US 2014/0236645 A1
(43) Pub. Date: Aug. 21, 2014

(54) Method And System For Remote Reservation Of A Parking Space, And Automated Vehicle Rental Facility

(71) Applicant: Bluecarsharing, Vaucresson (FR)

(72) Inventors: Francis Aaron, Houilles (FR); Clément Lambrinos, Montreuil (FR); Yousra Chebbi, Issy Les Moulineaux (FR); Aymeric Augustin, Ville D'avray (FR); Raphaël Barrois, Paris (FR); Sylvain Geron, Meudon (FR); Antoine Geron, Viroflay (FR)

(73) Assignee: BLUECARSHARING, Vaucresson (FR)

(21) Appl. No.: 14/348,018

(22) PCT Filed: Sep. 27, 2012
(86) PCT No.: PCT/FR2012/052174

§ 371 Date: Mar. 27, 2014

(30) Foreign Application Priority Data
Sep. 30, 2011 (FR) 1158786

(51) Int. Cl. G06Q 10/02

(52) U.S. Cl. CPC G06Q 10/02; G06Q 2240/00
USPC 705/5

(57) ABSTRACT

The invention relates to a method for reserving a parking space for a vehicle at a remote site also known as a rental site, in the context of automated vehicle rental, said method including a so-called reservation phase (200) including the following steps: determining (204-208) a so-called available remote rental site, in which a parking space is available, sending (214) a reservation request for a parking space in said available remote rental site, said reservation request including an identification data item also known as an identifier, storing (220) said identifier associated with an available parking space, and modifying (220) the status of said parking space. The invention likewise relates to a system implementing such a method and a use of such a method and such a system for automated vehicle rental.

The present invention relates to a method for the remote reservation of a parking space. It also relates to a system implementing such a method and an installation implementing such a method or such a system.

The field of the invention is the field of the remote reservation of a parking space within the context of the automated rental of vehicles over one or more rental sites each comprising at least one parking space. It relates in particular to the automated rental of electric vehicles, which need to be recharged when they are parked, for example between two rentals, so that the vehicles' batteries are recharged for a new rental, it being understood that a vehicle the batteries of which are discharged cannot be rented.

### STATE OF THE ART

Automated vehicle rental is a field experiencing rapid growth. In population centres where it is desirable to reduce the number of vehicles present in the area, automated vehicle rental systems are being established.

Installations for the rental of cycles are currently known. These installations comprise several rental sites, dispersed in a geographical area, and allowing users to collect a rental cycle or return a cycle at the end of rental in a completely automated manner. Thus, a user can collect a rental vehicle at a first site, use it during the rental period, and return it, at the end of rental, to a second rental site different from the first rental site.

The known rental sites comprise parking spaces arranged in order to receive a vehicle when the latter is no longer being rented. Each parking space is designed to receive a single vehicle. The reason for such a design is to ensure individual automated rental of the vehicles available for rental without human intervention. Thus, each rental site cannot receive more vehicles than there are parking spaces. Such a design is more important when the rented vehicles need to be recharged while parked, such as electric vehicles.

Such a situation can result in the overloading of a rental site, no longer allowing a user to return a rented vehicle there. The user finding himself in such an inconvenient situation then has to search for another rental site in order to return his vehicle there and terminate the rental. During this time, the vehicle still remains under rental and the user can be charged the corresponding amount. Moreover, the search for an available parking space constitutes what can be a significant waste of time, especially when no other rental site is situated close to the overloaded rental site.

A purpose of the invention is to overcome the abovementioned drawbacks.

Another purpose of the invention is to propose a method and a system for the remote reservation of parking spaces.

Another purpose of the invention is to propose a method and a system for the remote reservation of parking spaces within the context of an automated rental of vehicles allowing better management of the automated rental of a vehicle.

Finally another purpose of the invention is to propose a method and a system for the remote reservation of parking spaces within the context of automated vehicle rental making it possible to reduce the costs to users, associated with vehicle rental.

### DISCLOSURE OF THE INVENTION

The invention proposes to achieve at least one of the abovementioned purposes by a method for the reservation of a parking space for a vehicle in a remote site, called a rental site, within the context of automated rental of vehicles, said method comprising a phase, called a reservation phase, comprising the following steps:
determining a remote rental site, called the available site, in which a parking space is available,
transmitting a request for the reservation of a parking space in said available rental site, said reservation request comprising an item of identification data, called an identifier,
storing said identifier in association with an available parking space, for example with an identifier of the parking space, and
changing the status of said parking space.

Thus, the method according to the invention makes it possible to reserve a parking space before arriving at a rental site with a view to returning a rented vehicle. The method according to the invention allows the user to be sure of finding a parking space on arrival at the rental site.

The method according to the invention avoids a user having to search for an available parking site during a period of time for which he will be charged, which reduces the cost associated with the rental of the vehicle and the waste of time for the user.

The method according to the invention thus allows users to better manage the automated rental of vehicles, by guiding them until the end of rental.

By “available” rental site is meant a rental site comprising at least one parking space that is “available”, i.e. not occupied by another vehicle and not reserved.

By “reserved” rental site is meant the rental site where a parking space is reserved.

Advantageously, the identifier can comprise an identifier associated with the user.

The identifier associated with the user can be an identifier of the user or the identifier of a vehicle rented by the user. Preferably, it is an identifier specific to the user.

Such an identifier can be provided in order to be read at each rental site, in particular by a rental terminal and/or a charging terminal of the rental site, when the user arrives at the rental site.

The identifier can preferably be saved in an identification means of the RFID or barcode type.

The identifier can alternatively or additionally comprise a code to be entered using an alphanumeric keyboard at the rental site.

According to the invention, the reservation request can be transmitted:
directly to the available rental site in which the parking space is reserved, for example to a rental terminal of the rental site, or
to a site, called a central site, remote from the available rental site and connected to said remote rental site, said central site preferably relaying said rental request to said available rental site.

Such a central site makes it possible to centralize all the reservation requests and to direct each reservation request to the rental site in question.

The reservation request can also be processed by the central site (storing and changing steps carried out at the central site), the result of the reservation being transmitted to the rental site.

Advantageously, the reservation phase can moreover comprise, after the storage step, a step of changing the status of a signalling means, particularly an indicator light, at the reserved parking space. Thus, it can be brought to the notice of other users visually that the parking space is reserved and that it is no longer available.

In the case where the reservation parking space comprises a charging terminal, provided for charging an electric vehicle for example, the indicator light can be arranged at the charging terminal. In this case, the method according to the invention can, alternatively or additionally, comprise the locking of a means of access to the charging means situated inside the charging terminal, for example the locking of a lid closing a compartment in which these charging means are placed.

The method according to the invention can moreover, alternatively or additionally, comprise changing the position of a means controlling access to the parking space, such as a retractable parking post or barrier. Putting such a means in locked position, for example in the high position in the case of a retractable parking post, in the public road makes it possible to prevent access to the reserved parking space, and the occupation, including unauthorized occupation, of the parking space.

The method according to the invention can moreover comprise a phase, called return phase, of a rented vehicle to said reserved parking space, said return phase comprising the following steps:
identification by indicating an identifier, for example the identifier of the user or of the vehicle, for example by reading from an identification means or by entering on an alphanumeric keyboard. This step is preferably carried out at the rental site, for example on a rental terminal of the rental site;
comparing said indicated identifier with the identifier stored in association with the parking space, this step being preferably carried out at the central site or at a central site: in this case the method comprises transmitting the indicated identifier to the central site;
if the indicated identifier and the stored identifier are identical, allocating the parking space to said rented vehicle or to said user: if the comparison step is carried out at the central site, the central site sends the result of the comparison to the rental site.

The method according to the invention can moreover comprise indicating the allocated parking space to the user by means of an audible and/or visual message, for example by an indicator light. Such an indicator light can be arranged on an electric vehicle charging terminal or can be the screen of the charging terminal if the parking space comprises such a charging terminal.

Advantageously, when the indicated identifier and the stored identifier are identical, the return phase can moreover comprise a step of unlocking:
a means of access to an electric charging terminal when the allocated parking space is provided with such a terminal, such as for example a lid giving access to a compartment containing an electric socket, and/or
a means of vehicle access to the allocated parking space, such as for example a retractable parking post.

The phase of reservation by a user can advantageously be triggered according to any one of the following options:
directly from a rental terminal of a rental site remote from the available rental site,
directly from a currently rented vehicle, for example via a user interface,
by an operator, optionally contacted in particular by telephone by the user, the latter being able for example to be contacted from a rental terminal or from a vehicle,
over the Internet via a dedicated website, and
via a wireless telephone network on a wireless communication device, for example of the smartphone or PDA type, etc.

The available rental site can advantageously be chosen automatically depending on a destination notified beforehand by the user, for example automatically as the nearest rental site to the destination and comprising at least one available parking space. This embodiment is particularly applicable when the user makes his request from a vehicle or from a rental terminal, optionally equipped with a GPS-type global positioning system. This step of choice of the rental site is carried out by the central site.

The available rental site can also be chosen manually by the user, said method comprising the following steps:
designation of a rental site by a user, optionally from a plurality of sites selected beforehand depending on a destination notified beforehand by the user,
verification of the availability of said rental site designated by the user,
if said designated rental site contains at least one free parking space, selection of said rental site as available rental site.

The reservation phase can moreover comprise consultation of a database, preferably by a central management server arranged at a central site, of a database in which an item of availability data is stored for each rental site, each rental site being able to be identified using an identifier allocated to each rental site beforehand.

It will also be noted that, when the verification step determines that there are no parking spaces available in the site chosen by the user, the reservation phase can comprise a step proposing to the user the reservation of a parking space in one of the nearest sites.

This proposal step can be carried out by presenting to the user the nearest 8 sites or, preferably, the sites having at least one available parking space among the nearest 8 sites, the step of verification of the availability of these sites having been carried out for these 8 sites beforehand. These sites nearest to a predetermined site can preferably be directly associated with the rental site chosen from a database in order to avoid carrying out a calculation step for each reservation process.

According to the invention, the verification step can also be carried out before the actual selection step since the method according to the invention can propose to the user to view all the sites, preferably already located on a map, with information relating to the availability of parking spaces in the site, or only the available sites.

The method according to the invention can moreover comprise a phase of updating the availability of each rental site, said updating phase comprising, for each of the rental sites, the following steps:
determining the status of each parking space of said rental site, for example if the parking space is occupied by a vehicle or not and, in the case of an unoccupied parking space, if it is reserved or not: this step can be carried out by presence detection means at each parking space and by consulting a database listing the reserved parking spaces, this database can be be local at each rental site or central at a central site;
depending on said status of each parking space, determining an item of availability data for the rental site: this item of availability data can be preferably determined at a central management site, the latter receiving from each of the rental sites items of data relating to the status of each parking space.

Advantageously, the item of availability data of each rental site is stored in a database, preferably at the central site, for example in association with an identifier of the rental site.

The updating phase can be carried out periodically at a given frequency, for example every minute.

During the reservation phase, the parking space can be reserved for a predetermined period only, for example 90 minutes. The predetermined period can also be indicated by the user (within predetermined limits in order to avoid abuse by inconsiderate users).

In an advantageous embodiment, the reservation period can be variable and determined as a function of different criteria relating to:
the distance between the reservation location and the rental site where the parking space has been reserved, and/or
the time of day and/or time of year, which can make it possible to take into account the presence or not of congestion, and/or
a traffic condition that may alter the route or the journey time needed to the reserved rental site.

When the vehicle comprises guidance and global positioning means, the reserved rental site can be considered the destination of the vehicle, either automatically or after confirmation from the user. The user can then be guided all the way to the reserved rental site.

When a parking space is reserved, the coordinates of the reserved rental site can be stored in a memory of the vehicle or at the central site.

The time and the distance for the remainder of the journey to the reserved rental site can also be calculated. During the journey, the vehicle can also compare the remaining journey time with the remaining reservation period for the reserved parking space.

If it determines that the remaining journey time is longer than the remaining reservation period, it can carry out a reservation processing step, which can comprise one or more of the following steps:
warning the user by an audible and/or visual signal, telling him for example to call a call centre agent in order to resolve his situation; and/or
depending on the remaining distance to the destination site, requesting an extension of the reservation period or cancellation of the reservation.

The reservation of a parking space can also be carried out in advance for a timeslot chosen by the user, at a rental site also chosen by the user.

In this case, the step of determining the availability of the rental site is implemented in a timeslot preceding the chosen timeslot by a predetermined period (for example, 1 hour).

It will be noted that, if it is determined that the site has no available parking space, an operator of the service is asked to release a parking space at the rental site. As soon as a parking space is free, its identifier is associated with that of the user.

According to another aspect of the invention, a system is proposed for the reservation of a parking space for a vehicle at a remote site, called a rental site, within the context of the automated rental of vehicles, said system comprising:
means for determining a remote rental site, called available site, in which a parking space is available,
means for transmitting a request for the reservation of a parking space in said available rental site, said reservation request comprising an item of identification data, called an identifier,
means for storing said identifier in association with an available parking space, and
means for changing a status of said parking space.

In an advantageous version, the system according to the invention comprises a central server, called a management server, arranged at a central site remote from the rental sites and in communication with each of the rental sites via a LAN-type network.

The rental sites can comprise a rental terminal, in communication with the central site.

The means for determining an available rental site can comprise:
means for determining and updating an item of availability data for each rental site,
a database for storing said item of availability data in association with an identifier of each rental site,
a synthesis module of said database, identifying said available site among all the sites.

In a particular embodiment, the means for determining and updating the item of availability data can comprise:
for each rental site:
   means for detecting the presence of a vehicle or of an electrical connection at each parking space: advantageously these means can comprise, for each parking space, weighing means, a camera and/or means for detecting an electrical connection;
   a terminal, called a rental terminal, in communication with said detection means, for example via a local wired or wireless connection;
for all the rental sites, a common server, called a management server, arranged at a site, called a central site, remote from said rental sites and in communication with the rental terminal of each rental site via a communication network, for example of GPRS/3G or LAN type, or also both, the server preferably storing the database.

The means for transmitting a reservation request can comprise:
a communication module, called a vehicle communication module, arranged in each vehicle, in particular for the reservation requests triggered from a vehicle and/or
a terminal, called a rental terminal, in particular for the reservation requests triggered from a rental site, for example from the rental site where the vehicle is collected for rental, and/or
a portable device for communication via a wireless communication network;
   comprising means for communicating with a communication module, called a central communication module, arranged at a central site to which the reservation request is transmitted.

Communication between the means of transmission of a reservation request and the communication module is preferably carried out via a wireless mobile telephony network.

According to yet another aspect of the invention an installation is proposed for the automated rental of vehicles, comprising a plurality of rental sites each containing at least one parking space, said installation comprising a management system according to the invention or means for implementing the steps of the method according to the invention.

Other advantages and characteristics will become apparent on examination of the detailed description of embodiments which are in no way limitative, and the attached drawings in which:

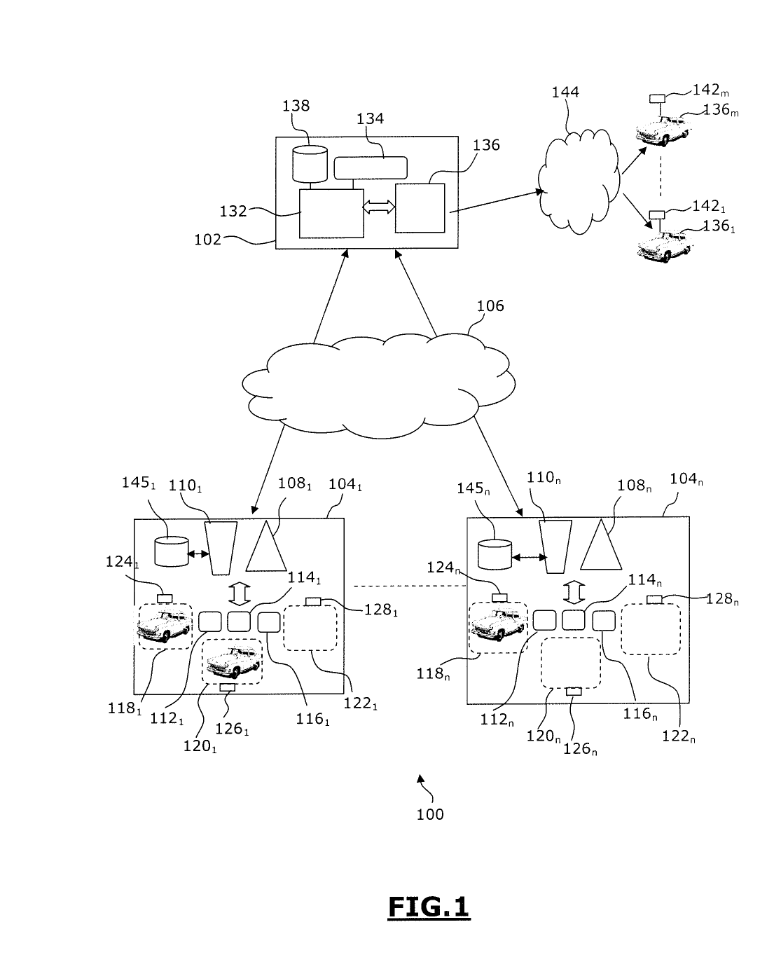

FIG. 1 is a diagrammatic representation of a vehicle rental installation implementing the method according to the invention.

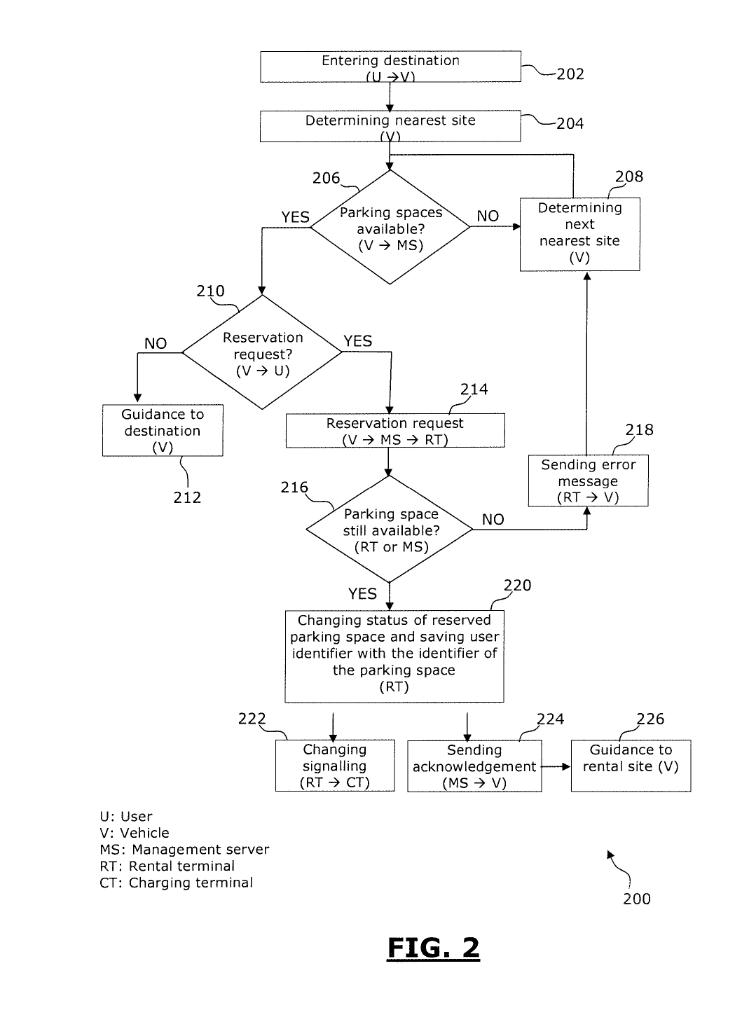

FIG. 2 is a diagrammatic representation in the form of a flow-chart of a method for the reservation of a parking space according to the invention;

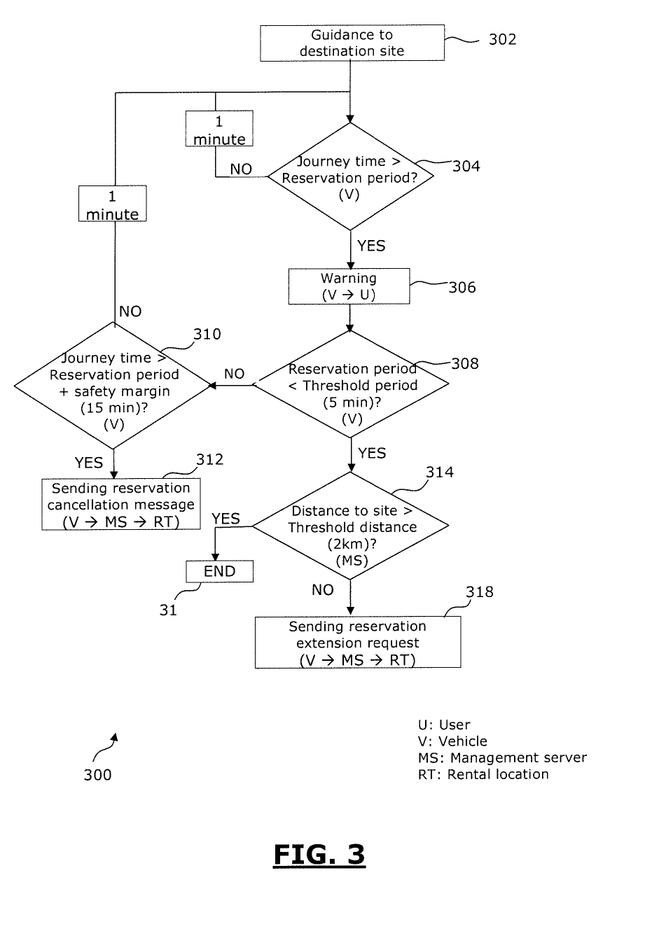

FIG. 3 is a diagrammatic representation in the form of a flow-chart of the management of a parking space reserved according to the method in FIG. 2;

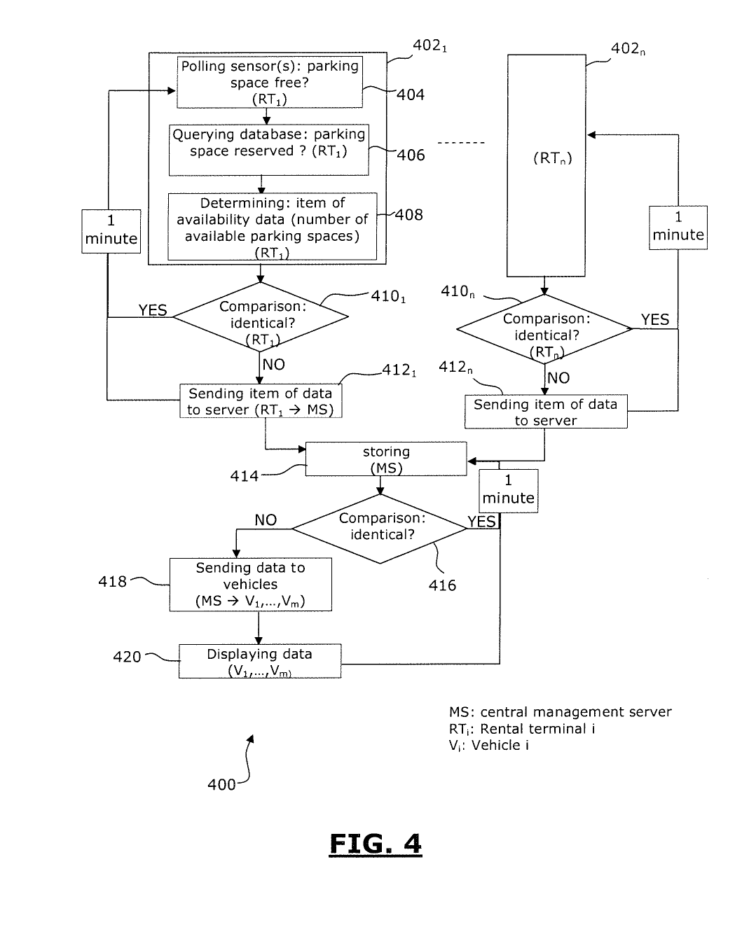

FIG. 4 is a diagrammatic representation in the form of a flow-chart of a phase of updating the availability data for the rental sites according to the invention; and

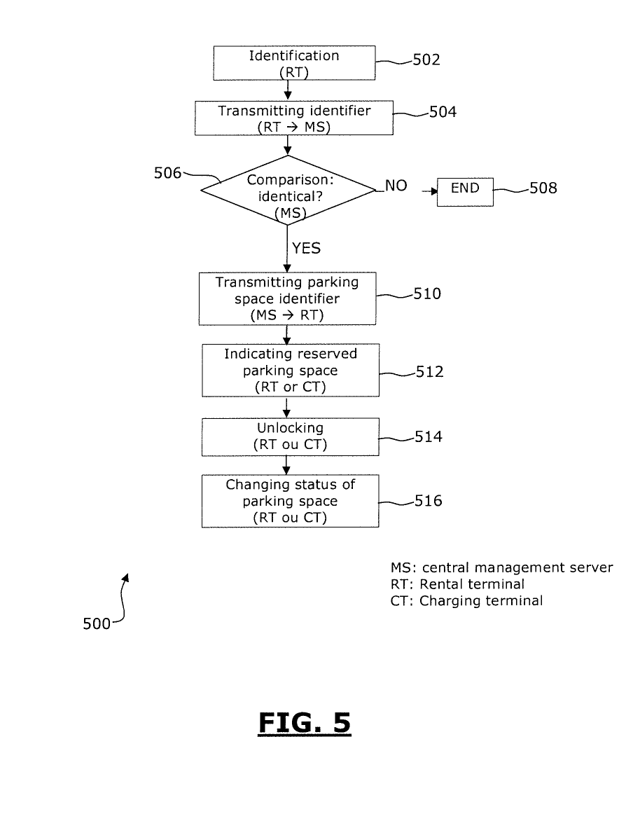

FIG. 5 is a diagrammatic representation in the form of a flow-chart of a phase of returning a vehicle according to the invention.

It is understood that the embodiments which will be described below are in no way limitative. In particular, variants of the invention can be envisaged that comprise only a selection of the features described below in isolation from the other features described, if this selection of features is sufficient to provide a technical advantage or to differentiate the invention from the prior art. This selection comprises at least one preferably functional feature without structural details, or with only part of the structural details if this part alone is sufficient to confer a technical advantage or to differentiate the invention from the state of the prior art.

In particular all the variants and embodiments described can be combined with each other if there is no technical objection to this combination.

In the figures and in the remainder of the description, the elements common to several figures retain the same reference number.

The examples described below relate to automated rental of electric vehicles over several rental sites.

FIG. 1 is a diagrammatic representation of an installation for the automated rental of electric vehicles.

The installation 100 shown in FIG. 1 comprises a central site 102 connected to several sites—or stations—104₁-104ₙ, called rental sites via a wireless communication network 106, for example GPRS, or a wired network, for example of DSL or LAN type. Preferably, each site 104 is connected to the central site via two separate networks, which enables continuous connection even if one of the networks fails.

Each rental site 104 comprises a rental terminal 110 for the rental of a vehicle and several charging terminals 112-116, each charging terminal being provided for charging a vehicle equipped with an electric battery at a parking space, namely parking spaces 118-122.

Some rental sites 104 also comprise a subscription terminal 108 for registering a new subscriber.

Each parking space of a rental site 104 comprises a presence detector module 124-128, namely weighing means, a camera and/or an infrared sensor and/or a detector of an electrical connection to a vehicle, connected to the rental terminal 110 of the rental site 104.

The central site 102 can be connected directly to each of the terminals of a rental site 104 via the network 106 or only to the subscription terminal and/or to the rental terminal and/or to the recharging terminals 112-116.

At least two terminals of a rental site are connected to each other by means of a wired connection (not shown).

The central site 102 comprises a central management server 132, a synthesis module 134 and a communication module 136, called a central module. The central site 102 moreover comprises a database 138 in which in association with each vehicle identifier, the identifier of the user to whom this vehicle is rented, and optionally the status of the vehicle (rented/nor rented/undergoing maintenance) are saved.

The central site 102 is in communication with currently rented electric vehicles 140₁-140ₘ, via the central communication module 136 and a communication box 142₁-142ₘ, called a vehicle communication box, arranged in each of the vehicles, via a wireless communication network 144, for example GPRS, which can be the same as the communication network 106.

By means of the central communication module 136 and the vehicle communication modules 142, the central site exchanges data with each of the vehicles 140.

Each vehicle communication module 142 is in connection with a user interface (not shown), for example an interface of a global positioning element of the vehicle, which can comprise a touch screen, for displaying the data thereon on a map and for taking into account the data entries made by the user of the vehicle 140.

The installation 100 makes it possible to manage a plurality of vehicles available for rental.

The users are capable of interacting with the different terminals as well as with the different elements of the vehicles. Moreover, the vehicle rental service with the installation according to the invention can also be carried out with the help of operators who can intervene in the service by means of their mobile terminal such as a PDA.

Each rental site 104 comprises a database 145 in which the reserved or unreserved status of each parking space 118 of the rental site 104 is saved. This database could also make it possible to save the availability status of each parking space, namely occupied or free.

FIG. 2 is a diagrammatic representation in the form of a flow-chart of a phase of remote reservation of a parking space for reservation according to the invention.

In the embodiment in FIG. 2, the reservation phase 200 is carried out from the currently rented vehicle.

The reservation phase 200 comprises a step 202 during which the user is questioned in order to determine the destination to which he wishes to go, then, once the destination has been entered, if he wishes to reserve a parking space on arrival.

If the user wishes to make the reservation, the site nearest to the precise destination is identified in step 204. For this, the coordinates of the destination are compared with the coordinates of the rental sites notified beforehand. The nearest rental site identified can be positioned on a map using for example a standard GPS system, capable of carrying out this type of calculation.

The vehicle calculates in particular the distance between each site of a set of preselected sites, for example the sites which have coordinates close to those of the destination, and the point of destination defined by the user. Each site positioned on the map is, of course, associated with its identifier so that the vehicle can obtain the identifier of the nearest site.

Once the nearest site has been defined, in step 206 the vehicle queries a database, for example at the central site management server, in order to find out the number of places available at the nearest identified site. The central server in fact centralizes the data on the availability of the parking spaces in the sites of the rental installation, periodically sent by the rental terminals of each site; more details will be given in the remainder of the description, in particular with reference to FIG. 4. The database of the central server comprises in particular an identifier of the site and the number of associated available places or a Boolean value relating to the existence of available parking spaces at the rental site. As a variant it could comprise a Boolean value for each parking space and a parking space identifier or even in addition, an identifier of the rental site.

It will be noted that, as a variant, the management server can also send the availability data to all the vehicles periodically.

Following the request by the vehicle to query the database, the central server sends to the vehicle the item of data on the availability of the station.

If there are no parking spaces available in the rental site, a step 208 determines the second nearest rental site and the step 206 is repeated, and so on until the nearest site which has at least one parking space available is identified.

Once the nearest available rental site has been identified, a step 210 questions the user in order to determine if he wishes to reserve a parking space in the available rental site identified in step 206.

If the user does not wish to reserve a parking space, a step 212 guides the user to the destination.

If, in step 210, the user wishes to reserve a parking space in the nearest rental site identified, then the destination is changed and the new destination corresponds to the address of the identified available site.

As a variant, the steps of determining the nearest available rental site can also be carried out simultaneously for all the sites, or optionally for all the sites nearest to the user's destination. It would also be possible to consult the item of availability data for all the sites nearest to the first site consulted, associated with the first site consulted in a database.

Then, in step 214, a reservation request is sent to the rental terminal of the nearest available rental site identified, optionally via the management server of the central site. The reservation request message comprises the user identifier, and optionally an indication of the reservation period. The reservation period could systematically be a period determined beforehand or determined at the management server or rental terminal. The period could also be chosen by the user or determined as a function of different parameters relating to the distance separating the vehicle from the identified rental site, and to traffic conditions, etc.

When the management server receives the message, it verifies in step 216 that the available parking space or spaces have not been used since step 206.

If there are no more free parking spaces remaining in the identified rental site, an error message is sent to the vehicle in step 218, and the steps are repeated from step 208. The rental terminal changes its light signal, for example by showing an indicator light at the top, in order to inform users that there is no space available at this rental site.

If there is an available parking space remaining, in step 220 the status of the latter is changed to “reserved”. Then the identifier of the user who has made the reservation request is saved with the identifier of the parking space to which the reservation relates.

In step 222, a message is sent to the rental terminal in order to notify it that the parking space is occupied and by means thereof to control the charging terminal associated with the parking space so that it displays a particular light indicator, for example by lighting an LED or by changing the colour of an indicator light and to signal to other users the non-availability of the parking space.

Step 222 can also carry out other measures such as controlling the deployment of a retractable parking post preventing parking.

In step 224, the management server triggers a countdown associated with the “reserved” status, for the duration of the reservation period notified, and then sends a message confirming the reservation. This message can indicate the time at which the countdown was triggered and/or the countdown end time.

A step 226 then guides the user to the reserved rental site.

It will be noted that numerous variants can be implemented for the management of the reserved parking space. For example, the user can reserve a parking space in the arrival site from the rental terminal of his departure site. He can also directly choose the site in which he wishes to leave the vehicle, without needing to indicate his destination. The sites can in fact be represented on an interactive map, for example at the parking space where they are situated and the available parking spaces at each rental site can be indicated on the map, the user thus being able make an informed choice of destination site.

FIG. 3 is a diagrammatic representation in the form of a flow-chart of a phase of management of a reserved parking space, in particular in the case where the user cannot reach the reserved rental site during the reservation period. The reservation phase 200 in FIG. 1 can be completed by the management phase 300 in FIG. 3.

During the journey, in step 302, the user is guided to the reserved rental site. The remaining journey time to the reserved site is calculated and updated, for example by a global positioning system.

In step 304, the remaining journey time is compared with the remaining reservation period.

If the remaining journey time is less than or equal to the remaining reservation period, this means that the vehicle will arrive at the reserved parking space before the end of the reservation period. Step 304 is repeated one minute later.

If in step 304, the remaining journey time is greater than the remaining reservation period a warning is sent to the user in step 306, using for example an audible signal, in order to ask him to call an operator for example.

A step 308 then compares the remaining reservation period with a threshold period, for example of 5 minutes.

If the remaining reservation period is greater than the threshold period, a step 310 compares the remaining journey time with the remaining reservation period+a predetermined safety margin, for example 15 minutes. If the remaining journey time is greater, the probability of the user reaching the reserved rental site during the remaining reservation period will be considered to be too low. A cancellation message is sent to the user and the reservation is cancelled in step 312. The reserved parking space is then available again. Otherwise, step 304 is repeated.

If in step 308, the remaining reservation period is less than the threshold period, a step 314 compares the remaining distance with the reserved site with a threshold distance, for example 2 km.

If the remaining distance is greater than the threshold distance, no action is taken.

If the remaining distance is greater than the threshold distance, an extension request is transmitted in step 318.

Of course, if the user does not arrive at the selected site before the expiration of the countdown, the rental terminal changes the status of the space to “available” and deletes the identifier of the user so that he is no longer associated with this parking space.

FIG. 4 is a diagrammatic representation in the form of a flow-chart of a phase of updating the availability data for the rental sites according to the invention.

The phase 400 of updating the availability data represented in FIG. 4 firstly comprises a data collecting step 402ᵢ carried out by the rental terminal RTᵢ of each rental site. This terminal determines for each parking space of each of the rental sites, which one is occupied. Step 402 is therefore carried out for each of the parking spaces of the rental site, either simultaneously or one after the other.

This step 402, comprises:
a step 404ᵢ, during which the rental terminal polls a presence sensor allocated to a parking space, for example a current loop situated on the roadway, under the parking space or also a detection sensor, such as a camera or an infrared sensor, situated for example on the charging terminal allocated to the parking space. The status of the parking space (free or occupied) can also be determined by detecting the connection of a vehicle to the charging means of the charging terminal allocated to the parking space. This type of detection does not however detect vehicles parked in the parking space in unauthorized manner, unlike detection using a presence sensor. It is also possible to poll both types of sensor simultaneously;
a step 406ᵢ during which a database is queried in order to determine if a free parking space is reserved or not; and
a step 408ᵢ during which the number of available parking spaces is counted. This number corresponding to the item of availability data for the site i.

After step 402ᵢ carried out for each of the parking spaces of the rental site, a step 410ᵢ carries out a comparison of the determined item of availability data with that determined previously.

If the items of data are identical, no data is sent and step 402ᵢ is repeated one minute later.

If there is a difference between the two items of availability data, the new item of availability data is communicated to the central site, and more particularly to the central management server, during a step 412ᵢ.

Steps 402-412 are carried out for each of the rental sites in parallel, either simultaneously or in staggered manner.

In step 414, the management server stores the received data in a database, for example the database 138 in FIG. 1. Each item of availability data for a rental site is saved in the database for example in association with an identifier of the rental site in question. The storage is carried out as the items of availability data are received from the different rental sites.

In step 416, the management server carries out a comparison between the data previously sent to the vehicles and the new availability data.

If the items of data are identical, no item of data is sent to the vehicles, and step 414 is repeated for example 1 minute later.

If the items of data are different, in step 418, the central management server sends, in the same transmission, the items of availability data for all the rental sites, to each of the fleet vehicles, namely to the rented vehicles and optionally to the vehicles which are not rented.

These data are then displayed in the vehicles in step 420 if the user so wishes.

Then step 414 is repeated 1 minute later.

It is also possible to envisage sending to the vehicles only the items of availability data which change, the availability data which do not change then not being sent. In this case, the vehicle display interface updates the display of the items of availability data for the rental sites to which the change relates, the display remaining unchanged for the other rental sites.

The data is sent to the vehicles by means of a wireless network such as a wireless telephone network (GPRS or 3G in particular).

As a variant, it is also possible to envisage that the reservation database is stored in the management server.

In this case, each rental site 104 sends to the management server the data on the occupation of the different parking spaces determined in step 202, following this step. Steps 404, 406 of consulting the reservation database and determining the status of each of the parking spaces, then of the item of availability data are then carried out by the management server.

The vehicle, in particular its user interface, has a GPS and stores in its memory the maps of the rental area. It also has GPS coordinates of the rental sites, also associated with their identifier, which makes it possible to place them correctly on the map. It is also configured in order to incorporate the transmitted items of availability data into the map. Each item of availability data is displayed on the map in relation to the representation of the corresponding site, in particular in the vicinity of the parking space of the site on the map. These maps are displayed on the user interface in order to allow the user access thereto. It will be noted that it is possible for these items of data to be displayed only if the vehicle is in operation, and in particular if the user wishes them to be displayed, in particular within the context of the GPS function.

The items of availability data received in the vehicle can be stored in a memory in the vehicle, particularly in the user interface.

The items of availability data can also be downloaded in real time and as needed, by the user interface from the central management server.

FIG. 5 is a diagrammatic representation in the form of a flow-chart of a vehicle return phase according to the invention.

The return phase 500 comprises a step 502 of identification of the user either by reading an identifier from an identification means or by entering a code using an alphanumeric keyboard.

The item of identification data entered in step 502 is sent to the management server in step 504.

In step 506 the item of identification data is compared with the stored items of identification data of the users who have reserved a parking space on this rental site.

If the item of identification data entered does not correspond to any stored item of identifier data, then the return phase is stopped in step 508 and the user is informed thereof.

If the item of identification data entered corresponds to a stored item of identifier data, then the identifier of the parking space is transmitted by the management server to the rental terminal in step 510.

The parking space is indicated to the user in step 512, for example by changing an indicator light or by indicating the number of the parking space.

The user then arrives at the parking space indicated, and can optionally identify himself again, for example at the charging terminal of the parking space. A predetermined period can be allowed for the user to carry out this operation.

As soon as the user arrives at the parking space, in step 514, the rental terminal or the charging terminal unlocks:
a means of access to the parking space, for example a retractable parking post which is brought to the low position in order to allow access to the reserved parking space for the returned vehicle, and/or
a means of access, for example a cover giving access to a housing, to electric charging means, such as for example a cable and/or an electrical connection point situated in the housing.

In step 516, once the user has successfully carried out all the operations for returning the vehicle and has terminated the rental, the signage of the parking space is changed from “reserved” to “occupied”.

Of course the invention is not limited to the examples which have just been described.

1. A method for the reservation of a parking space for a vehicle in a remote site, called a rental site, within the context of the automated rental of vehicles, said method comprising a phase, called a reservation phase, comprising the following steps:
determining a remote rental site, called the available site, in which a parking space is available, said determining step comprising, for at least one parking space of each of said rental sites, at least one of:
detecting the presence or not of a vehicle in said parking space by a presence sensor, or
detecting an electrical connection of a vehicle to a charging means associated with said parking space;
said available site being determined depending on said detection or detections;
transmitting, via a communication network, a request for the reservation of a parking space in said available rental site, said reservation request comprising an item of identification data, called an identifier,
storing said identifier in association with an available parking space, and
changing the status of said parking space.

2. The method according to claim 1, wherein the reservation request is transmitted:
directly to the available rental site in which the parking space is reserved, or
to a site, called a central site, remote from the available rental site and connected to said available rental site, said central site preferably relaying said rental request to said available rental site.

3. The method according to claim 2, further comprising storing at the central site at least one item of data relating to the parking space, the steps of storing and changing the status of the parking space being carried out at the central site.

4. The method according to claim 1, wherein the reservation phase further comprises, after the storing step, a step of changing the status of a signalling means, particularly of an indicator light, at the reserved parking space.

5. The method according to claim 1, further comprising a phase, called return phase, of a rented vehicle to said reserved parking space, said return phase comprising the following steps:
identifying at least one of the vehicle or a user by indicating an identifier,
comparing said indicated identifier with the identifier stored in association with the parking space, and
if the indicated identifier and the stored identifier are identical, allocating the parking space to said rented vehicle.

6. The method according to claim 5, wherein the return phase further comprises, when the stored identifier and the indicated identifier are identical, a step unlocking at least one of:
a means of access to an electric charging terminal when the allocated parking space is provided with such a terminal, or
a means of access to the vehicle or to the allocated parking space.

7. The method according to claim 1, wherein the reservation phase by a user is triggered:
directly from a rental terminal of a rental site remote from the available rental site,
directly from a currently rented vehicle,
over the Internet via a dedicated site, or
via a wireless telephone network on a wireless communication device.

8. The method according to claim 1, wherein the available rental site is chosen automatically, particularly by the central site, depending on a destination notified beforehand by the user.

9. The method according to claim 1, further comprising a phase of updating the availability of each rental site, said updating phase comprising, for each of the rental sites, the following steps:
determining the status of each parking space of said rental site, and
depending on said status of each parking space, determining an item of availability data for the rental site.

10. The method according to claim 1, further comprising changing the status of the parking space for a given period, such a period being at least one of:
a predetermined period,
a period calculated as a function of different criteria, such as the distance between the vehicle and the reserved parking space or the reservation period, or
a period chosen by the user.

11. The method according to claim 1, further comprising storing at least one item of data relating to the position of the parking space, so that the vehicle is guided to the reserved parking space.

12. The method according to claim 10, further comprising:
calculating a remaining journey time to the reserved parking space and comparing this time with a remaining reservation period so as to determine if the vehicle will arrive at the parking space before the end of the reservation period, and
if it is determined that the vehicle will not arrive at the parking space before the end of the reservation period, processing the reservation.

13. A system for the reservation of a parking space for a vehicle in a remote site, called a rental site, within the context of the automated rental of vehicles, said system comprising:
means for determining a remote rental site, called the available site, in which a parking space is available, said means comprising, for at least one parking space of each of said rental sites, at least one of:
a presence sensor for detecting the presence or not of a vehicle at said parking space, or
means for detecting an electrical connection of a vehicle to a charging means associated with said parking space;
said available site being determined depending on said detection or detections;
means for transmitting, via a communication network, a request for the reservation of a parking space in said available rental site, said reservation request comprising an item of identification data, called an identifier,
means for storing said identifier in association with an available parking space, and
means for changing the status of said parking space.

14. The system according to claim 13, wherein the means for determining an available rental site comprise:
means for determining and updating an item of availability data for each rental site,
a database for storing said item of availability data in association with an identifier of each rental site, and
a synthesis module of said database.

15. The system according to claim 14, wherein the means for determining and updating the item of availability data comprise:
for each rental site:
means for detecting the presence of a vehicle or of an electrical connection at each parking place, and
a terminal, called a rental terminal, in communication with said detection means; and
for all of the rental sites, a common server, called the management server, arranged at a site, called a central site, remote from said rental sites and in communication with the rental terminal of each rental site via a communication network and comprising means for storing the database.

16. An installation for the automated rental of vehicles over several rental sites, each rental site comprising at least one parking space, said installation:
comprising a system according to claim 13.

17. An installation for the automated rental of vehicles over several rental sites, each rental site comprising at least one parking space, said installation comprising means for implementing the steps of the method according to claim 1.
